(19) United States
(12) Patent Application Publication
(10) Pub. No.: US 2005/0172497 A1
(43) Pub. Date: Aug. 11, 2005

(54) Blade locking mechanism

(75) Inventors: Eric Linn, El Cajon, CA (US); Paul Naranjo, Lakeside, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Buck Knives, Inc., El Cajon, CA (US)

(21) Appl. No.: 10/777,465

(22) Filed: Feb. 11, 2004

Related U.S. Application Data
(63) Continuation-in-part of application No. 10/774,310, filed on Feb. 6, 2004.

(51) Int. Cl. B26B 1/04

(52) U.S. Cl. 30/161

(57) ABSTRACT

Disclosed is a folding knife that includes a handle with opposing sides, wherein the opposing sides define an opening for housing a blade when the blade is in a folded position. The folding knife further includes a protrusion that extends from one of the handle opposing sides into the opening for housing the blade. A blade is pivotally connected to the housing and the blade has a female portion aligned in the same plane as the blade. The folding knife also includes a locking mechanism that is pivotally connected to the housing for locking the blade in the closed position, the locking mechanism has a male portion for mating with the blade female portion when the blade is in a closed position. The locking mechanism further includes a recess for mating with the protrusion that extends from one of the handle opposing sides when the locking mechanism is in a locked position.

### CROSS-REFERENCES TO RELATED APPLICATIONS

This application is a continuation-in-part of an application entitled SPRING ASSIST KNIFE, filed on Feb. 6, 2004 by Express Mail, Label No. EL979145967US, the full disclosure of which is incorporated herein by reference.

### FIELD OF THE DISCLOSURE

The present disclosure relates to folding knives and, more particularly, locking mechanisms for folding knives.

### BACKGROUND OF THE DISCLOSURE

Pocket knives or folding knives typically include a locking mechanism to lock the blade in the open position so as to prevent the knife blade from inadvertently closing while the blade is in use or while the blade is in the open position.

There is a trend today to include a bias element in the knife to help open the knife blade relative to the knife handle; however, the locking mechanisms in folding knives have not kept up with the blade opening technology.

### BRIEF SUMMARY OF THE DISCLOSURE

Disclosed is a folding knife that includes a handle with opposing sides, wherein the opposing sides define an opening for housing a blade when the blade is in a folded position. The folding knife further includes a protrusion that extends from one of the handle opposing sides into the opening for housing the blade. A blade is pivotally connected to the housing and the blade has a female portion aligned in the same plane as the blade. The folding knife also includes a locking mechanism that is pivotally connected to the housing for locking the blade in the closed position, the locking mechanism has a male portion for mating with the blade female portion when the blade is in a closed position. The locking mechanism further includes a recess for mating with the protrusion that extends from one of the handle opposing sides when the locking mechanism is in a locked position.

Also disclosed is a method for locking a blade in a folding knife in a closed position, wherein the method includes the steps of retracting the blade into a housing for storing the blade when it is in a closed position, positioning a locking mechanism into a locked position so that a portion of the locking mechanism interfits with a portion of the blade, and temporarily locking the locking mechanism into place by interfitting the locking mechanism recess with a protrusion extending from the housing.

Also disclosed is a folding knife, that includes means for retracting the blade into a housing that houses the blade when it is in the closed position, means for positioning a locking mechanism into a locked position so that a portion of the locking mechanism interfits with the portion of the blade, and means for temporarily locking the locking mechanism into place by the locking mechanism having a recess interfitting with a protrusion extending from the housing.

### BRIEF DESCRIPTION OF THE DRAWINGS

FIG. 1 is a front perspective view of the folding knife according to the present disclosure with the blade in an open position;

FIG. 2 is a rear plan view of the folding knife according to the present disclosure with the blade in an open position;

FIG. 3 is a top elevational view of the folding knife according to the present disclosure with the blade in an open position;

FIG. 4 is a front plan view of the folding knife according to the present disclosure with the blade in a closed position;

FIG. 5 is a cross-sectional view taken from line 5-5 from FIG. 4;

FIG. 6 is a top elevational view of the folding knife according to the present disclosure with the blade in a closed and locked position;

FIG. 7 is an exploded view of the folding knife according to the present disclosure;

FIGS. 8A-8G are views of a number of positions of the folding knife according to the present disclosure with the blade going from a closed position to an open position and with the locking mechanism going from a locked position to an unlocked position;

FIG. 9 is a perspective cross-sectional view of the folding knife according to the present disclosure with the blade in a closed and locked position;

FIG. 10 is a perspective cross-sectional view of the folding knife according to the present disclosure with the blade in the open position and the locking mechanism in the locked position;

FIG. 11 is a cross-sectional view of the folding knife according to the present disclosure with the blade in a closed and the locking mechanism in the locked position;

FIG. 12 is a cross-sectional view of the folding knife according to the present disclosure with the blade in an unlocked and partially open position with the locking mechanism in an unlocked position;

FIG. 13 is a cross-sectional view of the folding knife according to the present disclosure with the blade in an unlocked and partially open position with the locking mechanism in an unlocked position;

FIG. 14 is a cross-sectional view of the folding knife according to the present disclosure with the blade in an open position with the locking mechanism in a locked position;

FIG. 15 is a top perspective view of the blade locking mechanism according to the present disclosure;

FIG. 16 is a front plan view of the locking mechanism according to the present disclosure;

FIG. 17 is a top elevational view of the locking mechanism according to the present disclosure; and

FIG. 18 is a bottom elevational view of the locking mechanism according to the present disclosure.

### DETAILED DESCRIPTION OF THE INVENTION

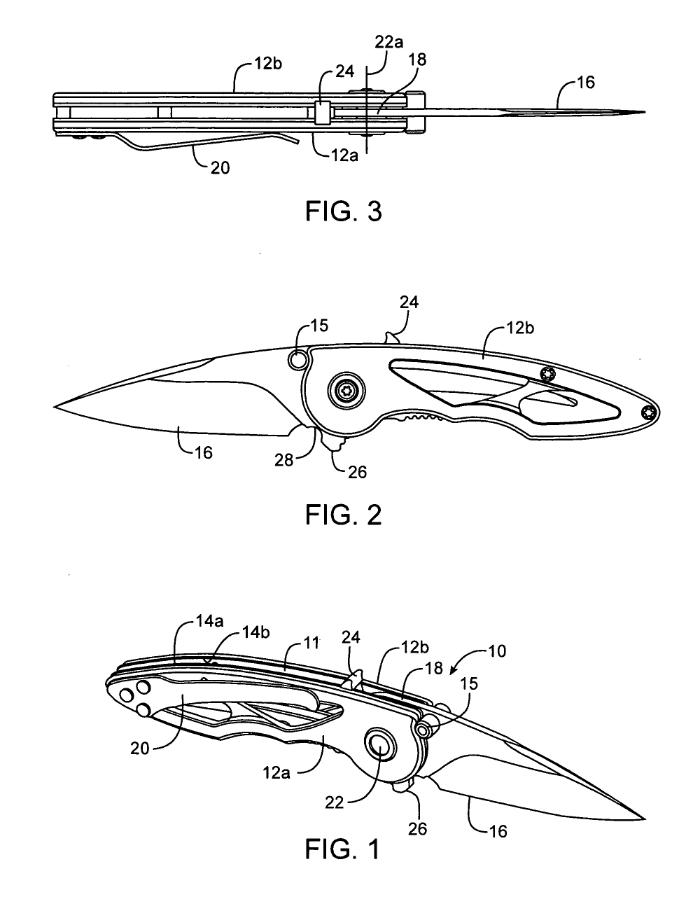

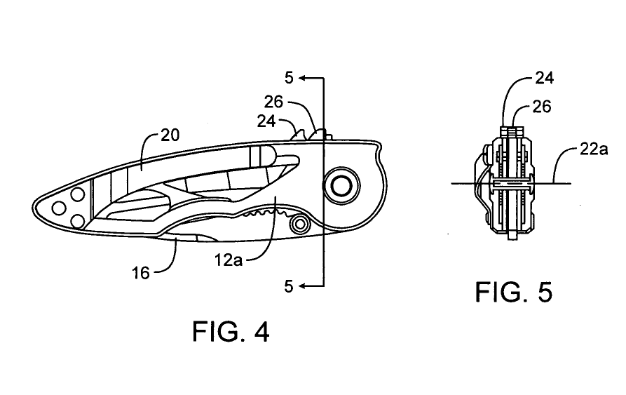

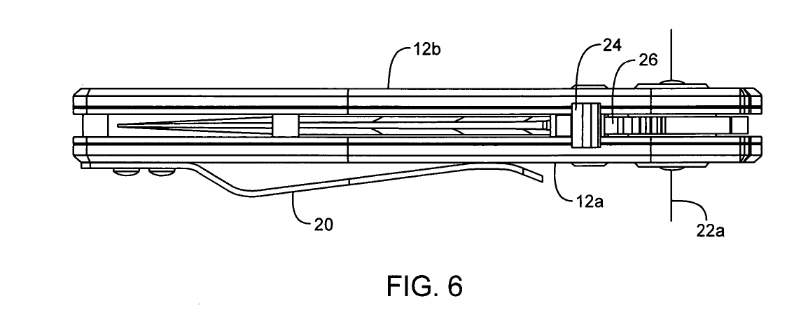

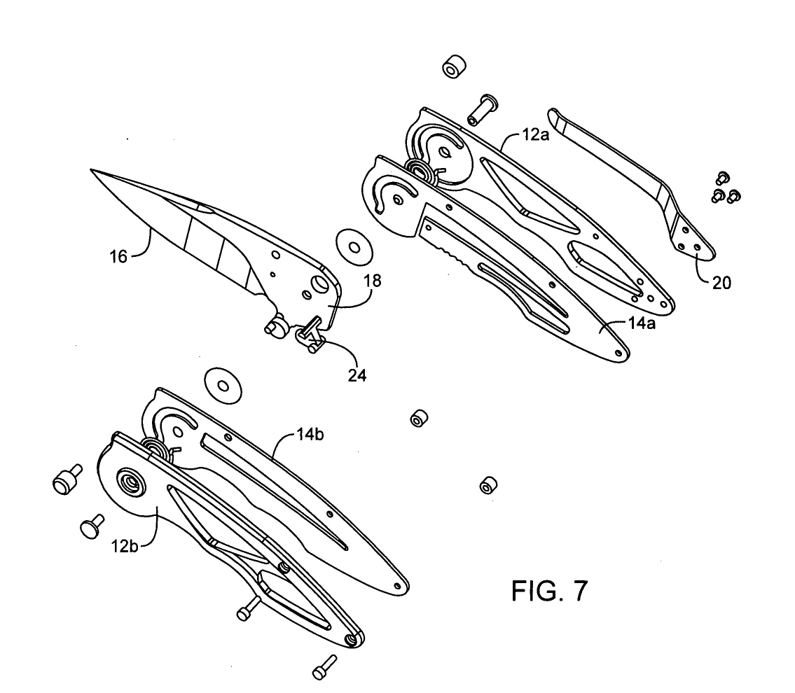

Disclosed herein is a folding knife with a locking mechanism for locking the blade in a closed or folded position so that the blade does not inadvertently open. This is especially helpful in a knife that has a bias element or spring which helps to open the blade relative to a handle or housing. The locking mechanism disclosed may, however, be used with a folding knife that does not have a bias element. As shown in FIGS. 1-7, a folding knife 10 includes a handle or housing 12 with opposing sides 12A and 12B defining an opening 11 for housing the blade when the blade is in a closed position. In one embodiment, the knife may include a pair of opposing liners 14A and 14B that are positioned internal of the handle pieces 12A and 12B, with the liners 14A and 14B defining the opening 11. The folding knife further includes a blade 16 with a blade base 18 that provides material for the blade 16 to pivot around a pivot pin 22 or the like that is located through the handle 12, the liner 14, and the blade base 18. In the embodiment shown, the folding knife further includes a clip 20 for clipping the folding knife onto a belt, pocket, or the like when the blade is not in use.

In the embodiment shown, the pivot pin 22 includes a pivot axis 22A that the blade 16 pivots about when the blade is moved from a closed to open position or when the blade is moved from an open to a closed position.

In the embodiment shown and described, the folding knife is a spring assisted knife wherein a spring, springs, or other bias elements help or assist in opening or pivoting the blade from a closed position to an open position. Disclosed herein is a locking mechanism 24 which locks the blade when it is in the closed position so that the blade does not inadvertently open, particularly in light of the biasing elements or the springs that are incorporated into the folding knife design to bias the blade to an open position. Therefore, as will be appreciated, the locking mechanism 24 of the present disclosure provides many benefits to a folded knife design, and especially to a folded knife design that utilizes a bias element to bias the blade to an open position by helping to prevent the inadvertent opening of the blade from the housing or from the handle 12.

The folding knife of the present disclosure further includes a blade tang 26, which may be used to assist in the initiating of the opening of the blade from the housing or the handle 12. Further, thumb stud 15 may be utilized to initiate the opening of the blade from the closed position. The blade 16 further includes a blade female portion 28 that is in the same plane as the blade and is adjacent to the blade base 18. In the embodiment shown, the blade female portion 28 is a radiused cutout from the blade 16, however, it will be appreciated that any configuration of the blade female portion may be utilized as long as the blade female portion mates with the male portion of the locking mechanism 24, which will be further described below.

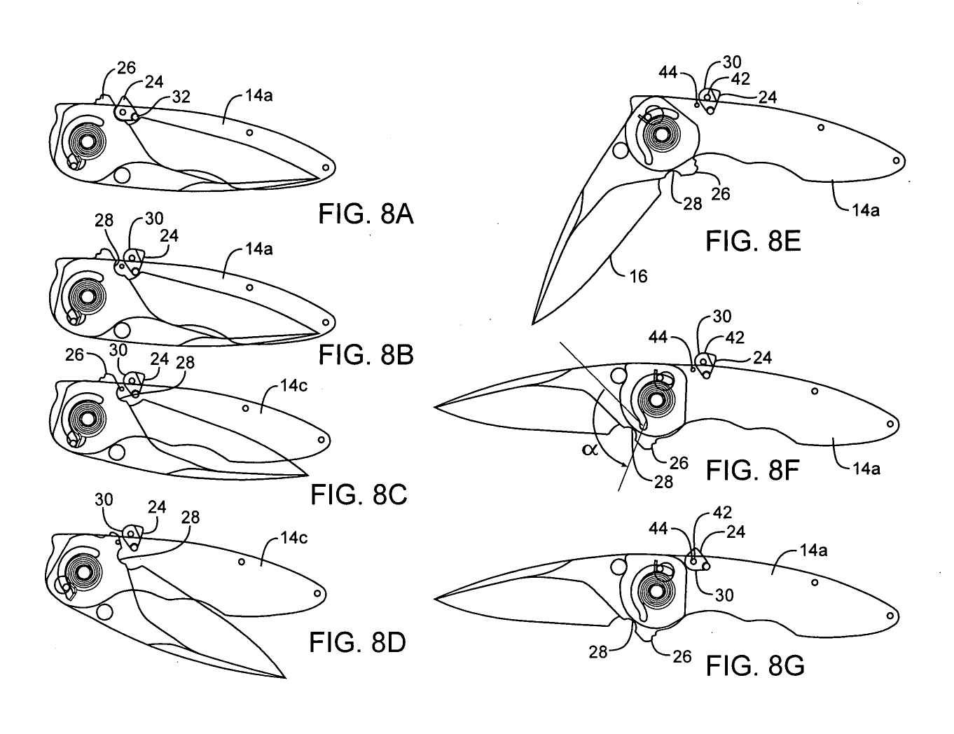

As shown in FIGS. 8A-8G, the locking mechanism 24 can include a male portion that substantially aligns with a female portion 28 in the blade. The female portion 28 is shown as positioned substantially on the same side as a blade edge. The locking mechanism 24 can include a recess 42 that aligns with a protrusion in a handle 14a of the knife. The protrusion can extend from the handle 14a inwards, towards the opposite handle (not shown in FIGS. 8A-8G).

As shown in FIG. 8G, the locking mechanism 24 may be repositioned in the locking position when the knife is in the fully open position. Additionally, the tang 26 on the blade can be positioned such that the blade tang 26 displaces the locking mechanism from the locked position when the blade is closed from the fully open position to a closed position. Thus, the locking mechanism 24 can be repositioned in the locked position when the blade is fully open in order to minimize protrusion from the knife. However, placing the locking mechanism in the locked position while the blade is open does not adversely affect the ability of the blade to return to the closed position.

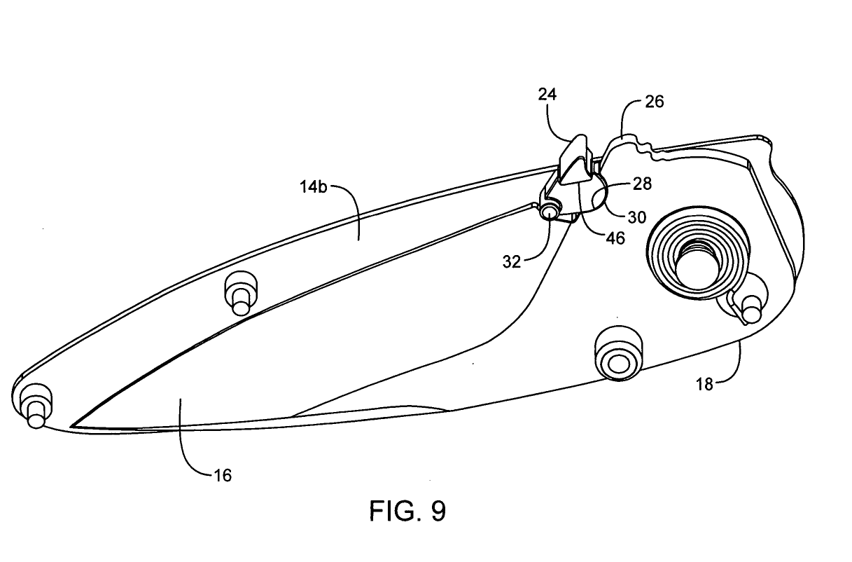

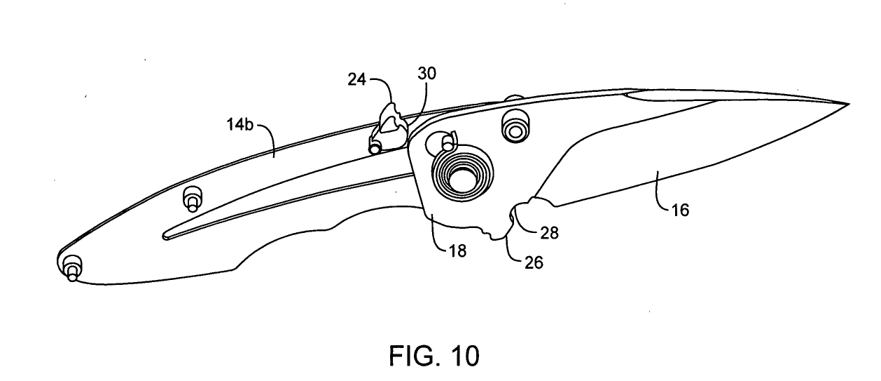

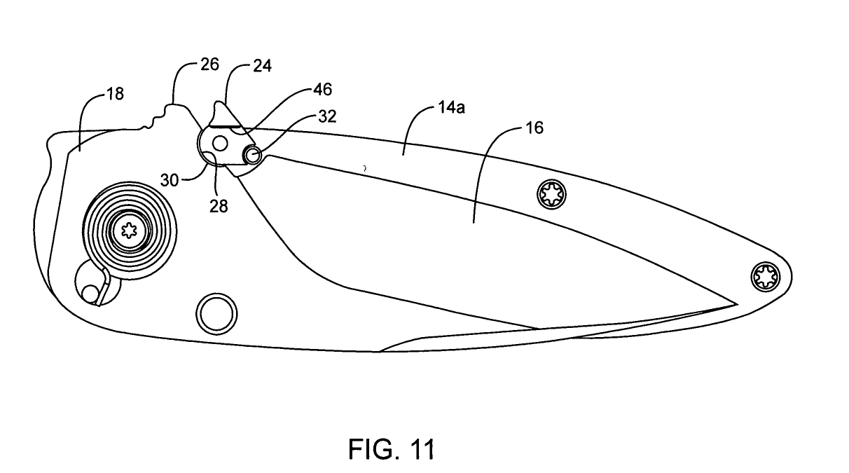

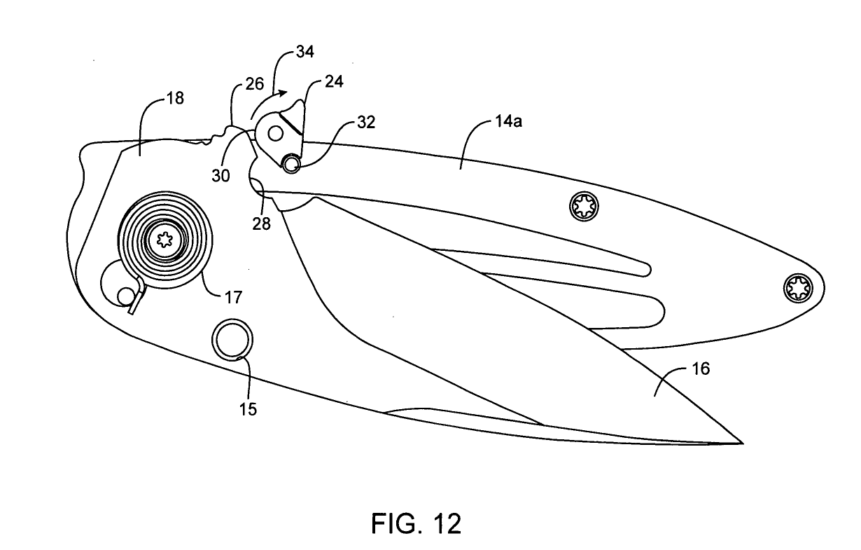

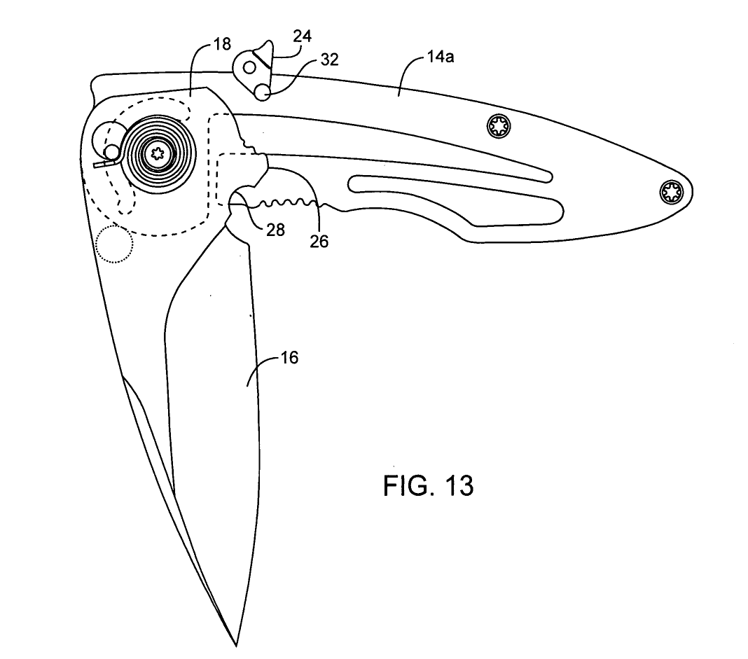

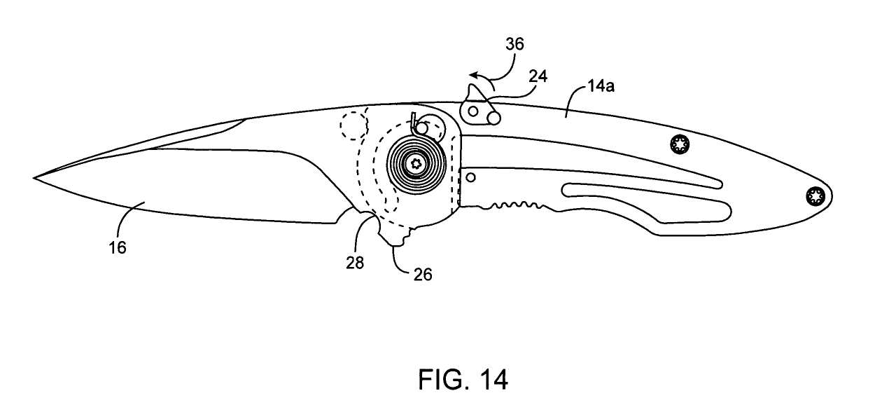

As shown in FIGS. 9-14, the locking mechanism 24 includes a male portion 30, which mates with or interfits with the blade female portion 28 when the blade is in a closed position and the blade is located in the housing, or between the handle pieces 12 and/or the liner pieces 14 and when the locking mechanism 24 is in the locked position. The locking mechanism 24 includes a pivot pin 32 that is sandwiched between the handle pieces 12 and/or the liner pieces 14, this allows the locking mechanism to pivot from the locked or forward position to and from the unlocked or aft position. As shown in FIG. 12, when the locking mechanism 24 is retracted by applying force to the locking mechanism in the aft direction, as indicated by arrow 34, the locking mechanism 24 pivots about the pivot pin 32 and the locking mechanism male portion 30 disengages from the blade female portion 28. When the locking mechanism is retracted and no longer engages the blade, the spring or springs 17 overtake the blade either independently or in combination with slight force applied by the user to either the thumb stud 15 and/or the blade tang 26. The progression of the blade opening is illustrated in FIGS. 11-14, and further illustrated in FIGS. 8A-8G. As shown in FIG. 14, when the blade is in the fully extended position, the locking mechanism 24 may be placed back into the locked position within the handle so as to minimize the protrusions extending from the knife assembly. The locking mechanism 24 is placed back into the opening 11 by applying a forward movement to the locking mechanism as indicated by arrow 36. When the locking mechanism is partially retracted to the aft position, the blade tang 26 pushes the locking mechanism to the aft position so that the blade freely opens to the open position.

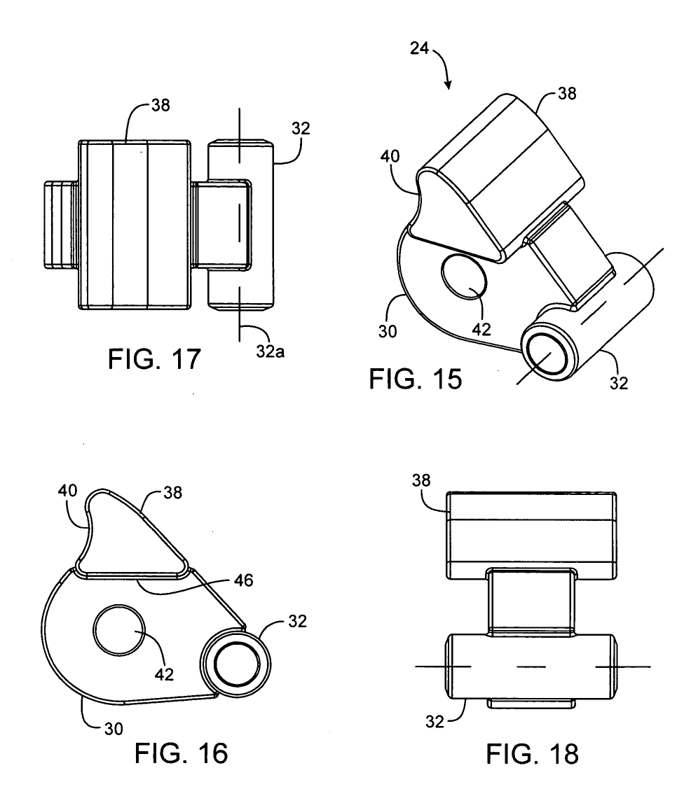

FIGS. 15-18 illustrate the details of the locking mechanism, independent of the knife assembly. The locking mechanism 24 includes a tab 38 which is the only section of the locking mechanism that protrudes from the knife assembly when the locking mechanism is in the locked position. The tab 38 includes a finger recess 40 so that a fingertip or fingernail may be positioned against the tab 38 for retracting the locking mechanism from the handle or liner so as to disengage the male portion 30 of the locking mechanism from the blade female portion 28. The locking mechanism further includes opposing flat surfaces 46 (only one side shown in these figures), so that the tab 38 may rest upon the top surface of the handle 12 and/or the liner 14 when the locking mechanism 24 is in the locked position. This is further illustrated in FIGS. 1, 2, 4, and 11, with only one side shown.

The locking mechanism 24 further includes a recess 42 which interfits with a protrusion 44 that extends from either a liner 14 or from the handle 12 into the opening 11. As shown in FIGS. 8A-8G, the locking protrusion 44 is positioned within the opening 11 on the interior surface of the handle 12 or the interior surface of the liner 14 so as to interfit with the locking recess 42 when the locking mechanism 24 is in the locked or closed position. The locking mechanism may be in the closed, but not locking the blade in the closed position if the blade is in the open position and the locking mechanism is in the closed position. The locking recess 42 and locking protrusion 44 provide resistance to the locking mechanism so that a small amount of force is required by the user to retract the locking mechanism from the locked position to the unlocked or open position, or to place the locking mechanism in the locked or closed position from the unlocked or open position. This further provides a positive lock to the locking mechanism to help lock the blade in the closed position and to prevent the blade from inadvertently opening.

It will be appreciated by those skilled in the art that any mating shape between the locking mechanism and the blade will allow for the locking mechanism to lock the blade in the closed position, and the shapes shown in the figures are exemplary only. Further, it will be further appreciated by those skilled in the art that having a protrusion from a liner and a recess in the locking mechanism may be easily reversed to accomplish the same objectives.

1. A folding knife, comprising:
a handle;
a blade pivotally connected to a handle; and
a locking mechanism connected to the handle to lock the blade in a closed position.

2. The folding knife according to claim 1, wherein the locking mechanism is pivotally connected to the housing for locking the blade in the closed position.

3. The folding knife according to claim 2, wherein the locking mechanism is located near a base portion of the blade.

4. The folding knife according to claim 3, wherein the locking mechanism further includes a male portion for mating with a blade female portion when the blade is in a closed position and when the locking mechanism is in a locked position.

5. The folding knife according to claim 4, wherein a protrusion extends from the handle and the locking mechanism further includes a recess for mating with the protrusion when the locking mechanism is in a locked position.

6. The folding knife according to claim 5, wherein the locking mechanism further includes a tab for manipulating the locking mechanism.

7. The folding knife according to claim 6, wherein the locking mechanism further includes a pivot pin for rotation within the handle.

8. The folding knife according to claim 1, further comprising a protrusion extending inward from the handle, and wherein the locking mechanism includes a recess configured to mate with the protrusion when the locking mechanism is in a locked position.

9. The folding knife according to claim 1, wherein the locking mechanism is further configured to be re-positioned in a locked position when the blade is in a fully open position.

10. The folding knife according to claim 9, wherein the blade is configured to displace the locking mechanism from the locked position when the blade is returned from the fully open position to the closed position.

11. A folding knife, comprising:
a housing for housing the blade when the blade is in the folded position;
a blade pivotally connected to the housing; and
a locking mechanism pivotally connected to the housing for locking the blade in the closed position.

12. The folding knife according to claim 11, wherein the locking mechanism further includes a male portion for mating with a blade female portion when the blade is in a closed position and when the locking mechanism is in a locked position.

13. The folding knife according to claim 11, wherein the locking mechanism further includes a tab for manipulating the locking mechanism.

14. The folding knife according to claim 12, wherein the locking mechanism further includes a pivot pin for rotation within the handle.

15. The folding knife according to claim 12 wherein the locking mechanism is further configured to be re-positioned in the locked position when the blade is in a fully open position.

16. The folding knife according to claim 15 wherein the blade includes a protrusion configured to displace the locking mechanism from the locked position when the blade is returned from the fully open position to the closed position.

17. The folding knife according to claim 11, wherein the locking portion further includes a male portion configured to align with a female portion when the blade is in a closed position, the female portion positioned on a same side as a blade edge.

18. A folding knife, comprising:
a handle with opposing sides to define an opening for housing the blade when the blade is in the folded position;
a protrusion extending from one of the opposing sides into the opening;
a blade pivotally connected to the housing; and
a locking mechanism pivotally connected to the housing for locking the blade in the closed position, the locking mechanism having a recess for mating with the protrusion to when the locking mechanism is in a locked position.

19. A folding knife, comprising:
a handle with opposing sides to define an opening for housing the blade when the blade is in the folded position;
a protrusion extending from one of the handle opposing sides into the opening;
a blade pivotally connected to the housing, the blade having a female portion; and
a locking mechanism pivotally connected to the housing for locking the blade in the closed position, the locking mechanism having a male portion for mating with the blade female portion when the blade is in a closed position, and the locking mechanism further having a recess for mating with the protrusion when the locking mechanism is in a locked position.

20. The folding knife according to claim 19, wherein the female portion of the blade is positioned along a sharpened edge side of the blade.

21. The folding knife according to claim 19, wherein the locking mechanism is configured to be repositioned to the locking position when the blade is in a fully open position.

22. A method for locking a blade in a folding knife in a closed position, comprising:
retracting the blade into a housing for storing the blade when it is in the closed position;
positioning a locking mechanism into a locked position so that a portion of the locking mechanism interfits with a portion of the blade; and
temporarily locking the locking mechanism into place by a recess interfitting with a protrusion extending from the housing.

23. A folding knife, comprising:
means for retracting the blade into a housing for storing the blade when it is in the closed position;
means for positioning a locking mechanism into a locked position so that a portion of the locking mechanism interfits with a portion of the blade; and
means for temporarily locking the locking mechanism into place by a recess interfitting with a protrusion extending from the housing.
